(19) United States
(12) Patent Application Publication
(10) Pub. No.: US 2009/0258045 A1
(43) Pub. Date: Oct. 15, 2009

(54) STRUCTURES INCLUDING ANTIMICROBIAL PEPTIDES

(75) Inventors: Helen F. Chuang, Pasadena, CA (US); Anita Shukla, Cambridge, MA (US); Christopher R. Loose, Cambridge, MA (US); Paula T. Hammond-Cunningham, Newton, MA (US); Gregory Stephanopoulos, Winchester, MA (US)

Correspondence Address: CHOATE, HALL & STEWART LLP, TWO INTERNATIONAL PLACE, BOSTON, MA, 02110, US

(73) Assignee: Massachusetts Institute of Technology, Cambridge, MA (US)

(21) Appl. No.: 12/406,369

(22) Filed: Mar. 18, 2009

Related U.S. Application Data
(60) Provisional application No. 61/037,428, filed on Mar. 18, 2008.

(51) Int. Cl. A01N 25/08; A01P 1/00

(52) U.S. Cl. 424/409

(57) ABSTRACT

A structure includes a substrate and a first plurality of bilayers on the substrate. The first plurality of bilayers includes a first layer including an antimicrobial peptide having a charge, and a second layer including a polyelectrolyte having a charge opposite the charge of the first layer. At least a portion of the structure is capable of degrading by sequential removal of the first layer and the second layer, and releasing the antimicrobial peptide from the structure.

### CROSS-REFERENCE To RELATED APPLICATION

This application claims the priority of U.S. Provisional Application Ser. No. 61/037,428, filed Mar. 18, 2008, and entitled, “Layer-by-layer Thin Films For Tunable Delivery of Antimicrobial Peptides,” the entire contents of all of which are incorporated herein by reference.

### TECHNICAL FIELD

The invention relates to structures that include antimicrobial peptides (AmPs).

### BACKGROUND

The layer-by-layer (LBL) adsorption of oppositely-charged polyelectrolytes on surfaces is a technique for the fabrication of thin multi-layer films, often with nanometer-scale control over the spatial distribution of ionized species within a film. The LBL technique is based on electrostatic attractions between polyelectrolytes and oppositely charged surfaces. For example, a negatively charged substrate is first dipped in a polycation solution. Electrostatic attractions result in deposition of the polycation and a resulting reversal of surface charge. The positively charged substrate is then submerged in a polyanion solution, resulting in deposition of the polyanion and restoration of the negative charge on the surface. Repetition of these steps leads to a buildup of layers of alternating, oppositely charged polyelectrolytes on the surface of the substrate. In addition to electrostatics, other factors and secondary interactions, such as hydrophobicity, salt interactions, solvent quality, polymer concentrations, and deposition time, may affect the multi-layer growth of the film.

The array of materials available for LBL assembly includes, for example, synthetic polyelectrolytes, conducting polymers, dyes, and metal colloids, as well as a variety of biological species, such as proteins, viruses, and DNA. Potential applications include conductive and light-emitting films, biologically-active surfaces, selective membranes, patterned films, and hollow multi-layer structures.

### SUMMARY

The invention relates to structures that include antimicrobial peptides (AmPs). Examples of structures include degradable structures formed by a layer-by-layer technique.

In one aspect, the invention features a structure including a substrate; a first plurality of bilayers on the substrate, the first plurality of bilayers including a first layer having an antimicrobial peptide having a charge, and a second layer having a polyelectrolyte having a charge opposite the charge of the first layer, wherein at least a portion of the structure is capable of degrading by sequential removal of the first layer and the second layer, and releasing the antimicrobial peptide from the structure.

In another aspect, the invention features a method including forming on a substrate a structure including a first plurality of bilayers on the substrate, the first plurality of bilayers having a first layer having an antimicrobial peptide having a charge, and a second layer having a polyelectrolyte having a charge opposite the charge of the first layer, wherein at least a portion of the structure is capable of degrading by sequential removal of the first layer and the second layer, and releasing the antimicrobial peptide from the structure.

In another aspect, the invention features a method including releasing an antimicrobial peptide from a structure including a substrate; a first plurality of bilayers on the substrate, the first plurality of bilayers including a first layer having the antimicrobial peptide having a charge, and a second layer including a polyelectrolyte having a charge opposite the charge of the first layer.

Embodiments of any of the aspects may include one or more of the following features. The antimicrobial peptide is selected from the group consisting of dermaseptin, melittin, defensin, chromofungin, gramicidin, cecropin-A-melittin hybrid, and ponericin. The second plurality of bilayers is between the substrate and the first plurality of bilayers. The first plurality of bilayers is between the substrate and the second plurality of bilayers. At least one of the first plurality of bilayers and the second plurality of bilayers includes alternating polycationic and polyanionic layers, and degradation of the structure is characterized by hydrolytic degradation of at least a portion of a member of the polycationic layers, the polyanionic layers, and both. At least one of the first plurality of bilayers and the second plurality of bilayers includes a polymer selected from polyesters, polyanhydrides, polyorthoesters, polyphosphazenes, polyphosphoesters, and any combination thereof. The polyesters are selected from poly(β-amino ester)s, poly(L-lactide-co-L-lysine), poly(serine ester), poly(4-hydroxy-L-proline ester), poly[.alpha.-(4-aminobutyl)-L-glycolic acid], and any combination thereof. At least one of the first plurality of bilayers and the second plurality of bilayers includes a polymer selected from poly(styrene sulfonate), poly(acrylic acid), linear poly(ethylene imine), poly(diallyl dimethyl ammonium chloride), poly(allylamine hydrochloride), and any combination thereof.

The structure can further include a second plurality of bilayers on the substrate, the second plurality of bilayers having a third layer having a charge, and a fourth layer having a charge opposite the charge of the third layer. The third layer can include a protein, a growth factor, or a peptide. At least one of the third layer or the fourth layer can include a polyelectrolyte.

At least one of the first plurality of bilayers and the second plurality of bilayers can include a biodegradable polymer. The biodegradable polymer can be selected from polyhydroxyacids, polypropylfumerates, polycaprolactones, polyamides, poly(amino acids), polyacetals, polyethers, biodegradable polycyanoacrylates, biodegradable polyurethanes, polysaccharides, and co-polymers, mixtures, and adducts thereof.

At least one of the first plurality of bilayers and the second plurality of bilayers can include a zwitterionic polymer. At least one of the first plurality of bilayers and the second plurality of bilayers can include covalently cross-linked compounds. The cross-link can be formed by a reaction including one or more of a double bond, carboxyl, thiol, amine, hydroxyl, halogen, carbodiimide, isocyanate, 3-[(2-aminoethyl)dithio]propionic acid, and succinimidyl 4- [N-maleimidomethyl]cyclohexalle-1-carboxylate.

The second plurality of the bilayers can include an entity selected from a biomolecule, a small molecule, a bioactive agent, and any combination thereof.

The structure can include a layer of cells on a surface of the structure. The cells can be selected from connective tissue cells, organ cells, muscle cells, nerve cells, stem cells, cancer cells, and any combination thereof.

The structure can include a member of a cell adhesion sequence, a targeting sequence, and both disposed in a top layer of the structure.

Degradation can be characterized by at least one of hydrolytic degradation, thermal degradation, enzymatic degradation, and photolytic degradation.

The first layer and the second layer can be formed layer-by-layer.

At least a portion of the structure is capable of degrading by sequential removal of the first layer and the second layer.

The antimicrobial peptide can be released into a living organism.

The method can include implanting the degradable structure in a living organism.

The method can include contacting the degradable structure to an area selected for medical treatment.

Embodiments of any of the aspects of the inventions may include one or more of the following features. The degradation rate of any of the layers varies such that the decomposition rate of the structure is not a constant.

The structure can include an entity associated with a polyelectrolyte in a layer. The entity can be associated via an interaction selected from covalent bond, a hydrogen bond, an electrostatic interaction, a van der Waals interaction, a hydrophobic interaction, a magnetic interaction and any combination of the above. The entity can be mixed with a polyelectrolyte in a layer of the thin film.

Within at least one of the layers (e.g., a polyelectrolyte bilayer), one or more polyelectrolyte layers can be covalently cross-linked to one another. The cross-link can be formed by a reaction including one or more of a double bond, carboxyl, thiol, amine, hydroxyl, halogen, carbodiimide, isocyanate, 3-[(2-aminoethyl)dithio]propionic acid, and succinimidyl 4-[N-maleimidomethyl]cyclohexalle-1-carboxylate. At least one covalently cross-linked polyelectrolyte bilayer can prevent diffusion of the entity within the thin film.

The substrate can be a non-planar substrate. For example, the substrate can have a shape selected from particles, tube, sphere, strand, coiled strand, and capillary network. Degradation of can enable dissolution of the substrate material. The substrate can include a drug. The surface properties of the substrate can vary across a surface of the substrate. The substrate can include a material selected from metals, metal oxides, plastics, ceramics, silicon, glasses, mica, graphite, hydrogels, polymers, and any combination thereof. A primer layer can be interposed between a thin film and the substrate, wherein the primer layer comprises a polyelectrolyte bilayer. 44. The primer layer can include a polymer selected from poly(styrene sulfonate) and poly(acrylic acid) and a polymer selected from linear poly(ethylene imine), poly(diallyl dimethyl ammonium chloride), and poly(allylamine hydrochloride).

A thin film can be adapted and constructed as a hollow shell.

Degradation can be at least partially hydrolytic, at least partially enzymatic, at least partially thermal, and/or at least partially photolytic. 103.

Other aspects, features and advantages will be apparent from the description of the following embodiments and from the claims.

### BRIEF DESCRIPTION OF DRAWINGS

FIG. 1 is a schematic diagram of an embodiment of a degradable structure.

FIG. 2 shows growth Curves for [(Poly X/HA)(AmP/HA)]ₙ at the early regime with various Poly Xs and AmPs.

FIG. 3 shows cumulative release of Dermaseptin (Derm) from [(Poly X/HA)(Derm/HA)]ₙ films formulated with various Poly Xs, each assessed at both room temperature (25° C.) and physiological temperature (37° C.).

FIG. 4 shows cumulative Dermaseptin and Melittin releases from (Poly 1/HA)(AmP/HA)]₁₀₀. Release assessment was based on BCA rather than FITC signal.

FIGS. 5A and 5B show release of Dermaseptin from a [(Poly 2/Hep)(bFGF/Hep)]₂₀+[(Poly 1/HA)(Derm/HA)]₁₀₀ film: (5A) release curve zoomed in to the first day, and (5B) overall release curve as assessed over 20 days.

FIGS. 6A and 6B show release of Ponericin G1 (Pon) from [(Poly 1/HA)(Pon/HA)]₂₅: (6A) release curve zoomed in to the first 2 days to display the 80% release profile, and (6B) overall release curve as assessed over 13 days.

FIGS. 7A and 7B show activity of Ponericin against S. aureus proliferation as administered in two forms: (7A) in a free solution of 0.1M sodium acetate, mimicking dipping solution condition, (7B) from an elution buffer of [(Poly 1/HA)(Pon/HA)]₁₀₀.

FIG. 8 shows release or Ponericin from a structure including [(Poly 2/Chondroitin Sulfate)(bFGF/Chondroitin Sulfate)]₃₀+[(Poly 2/HA)(Pon/HA)]₇₅

### DEFINITIONS

“Bioactive agents”: As used herein, “bioactive agents” is used to refer to compounds or entities that alter, inhibit, activate, or otherwise affect biological or chemical events. For example, bioactive agents may include, but are not limited to, anti-AIDS substances, anti-cancer substances, antibiotics, immunosuppressants, anti-viral substances, enzyme inhibitors, neurotoxins, opioids, hypnotics, anti-histamines, lubricants, tranquilizers, anti-convulsants, muscle relaxants and anti-Parkinson substances, anti-spasmodics and muscle contractants including channel blockers, miotics and anti-cholinergics, anti-glaucoma compounds, anti-parasite and/or anti-protozoal compounds, modulators of cell-extracellular matrix interactions including cell growth inhibitors and anti-adhesion molecules, vasodilating agents, inhibitors of DNA, RNA or protein synthesis, anti-hypertensives, analgesics, antLi-pyretics, steroidal and non-steroidal anti-inflammatory agents, anti-angiogenic factors, anti-secretory factors, anticoagulants and/or antithrombotic agents, local anesthetics, ophthalmics, prostaglandins, anti-depressants, anti-psychotic substances, anti-emetics, and imaging agents. In certain embodiments, the bioactive agent is a drug.

A more complete listing of bioactive agents and specific drugs suitable for use in the present invention may be found in “Pharmaceutical Substances: Syntheses, Patents, Applications” by Axel Kleemann and Jurgen Engel, Thieme Medical Publishing, 1999; the “Merck Index: An Encyclopedia of Chemicals, Drugs, and Biologicals”, Edited by Susan Budavari et al., CRC Press, 1996, and the United States Pharmacopeia-25/National Formulary-20, published by the United States Pharmacopial Convention, Inc., Rockville Md., 2001, all of which are incorporated herein by reference.

“Biomolecules”: The term “biomolecules”, as used herein, refers to molecules (e.g, proteins, amino acids, peptides, polynucleotides, nucleotides, carbohydrates, sugars, lipids, nucleoproteins, glycoproteins, lipoproteins, steroids, etc.) whether naturally-occurring or artificially created (e.g., by synthetic or recombinant methods) that are commonly found in cells and tissues. Specific classes of biomolecules include, but are not limited to, enzymes, receptors, neurotransmitters, hormones, cytokines, cell response modifiers such as growth factors and chemotactic factors, antibodies, vaccines, haptens, toxins, interferons, ribozymes, anti-sense agents, plasmids, DNA, and RNA.

“Biocompatible”: The term “biocompatible”, as used herein is intended to describe materials that do not elicit a substantial detrimental response in vivo.

“Biodegradable”: As used herein, “biodegradable” polymers are polymers that degrade fully under physiological or endosomal conditions. In preferred embodiments, the polymers and biodegradation byproducts are biocompatible. Biodegradable polymers are not necessarily hydrolytically degradable and may require enzymatic action to fully degrade.

“Degradation”: The phrase “degradation”, as used herein, relates to the cleavage of a covalent polymer backbone. Full degradation of a polymer breaks the polymer down to monomeric species.

“Hydrolytically degradable”: As used herein, “hydrolytically degradable” polymers are polymers that degrade fully in the sole presence of water. In preferred embodiments, the polymers and hydrolytic degradation byproducts are biocompatible. As used herein, the term “non-hydrolytically degradable” refers to polymers that do not fully degrade in the sole presence of water.

“Physiological conditions”: The phrase “physiological conditions”, as used herein, relates to the range of chemical (e.g, pH, ionic strength) and biochemical (e.g., enzyme concentrations) conditions likely to be encountered in the intracellular and extracellular fluids of tissues. For most tissues, the physiological pH ranges from about 7.0 to 7.4.

“Polyelectrolyte” or “polyion”: The terms “polyelectrolyte” or “polyion”, as used herein, refer to a polymer which under some set of conditions (e.g., physiological conditions) has a net positive or negative charge. Polycations have a net positive charge and polyanions have a net negative charge. The net charge of a given polyelectrolyte or polyion may depend on the surrounding chemical conditions, e.g., on the pH.

“Small molecule”: As used herein, the term “small molecule” is used to refer to molecules, whether naturally-occurring or artificially created (e.g., via chemical synthesis), that have a relatively low molecular weight. Typically, small molecules are monomeric and have a molecular weight of less than about 1500 g/mol. Preferred small molecules are biologically active in that they produce a local or systemic effect in animals, preferably mammals, more preferably humans. In certain preferred embodiments, the small molecule is a drug. Preferably, though not necessarily, the drug is one that has already been deemed safe and effective for use by the appropriate governmental agency or body. For example, drugs for human use listed by the FDA under 21 C.F.R. sctn.sctn.330.5, 331 through 361, and 440 through 460; drugs for veterinary use listed by the FDA under 21 C.F.R. .sctn.sctn.500 through 589, incorporated herein by reference, are all considered acceptable for use in accordance with the present invention.

### ACRONYMS

The following acronyms are used herein: “HA” is hyaluronic acid (otherwise known as “sodium hyaluronan” or “hyaluranon”, “Derm” is Dermaseptin, “Mel” is Melittin, “Pon” is Ponericin G1, “SPS” is poly(styrene sulfonate), “PAA” is poly(acrylic acid), “LPEI” is linear poly(ethylene imine), “PDAC” is poly(diallyl dimethyl ammonium chloride), “PAH” is poly(allylamine hydrochloride), and “PAZO” is the azobenzene functionalized polymer poly {1-[4-(3-carboxy-4-hydroxyphenylazo)benzensulfonamido]-1,2-ethanediyl}.

### DETAILED DESCRIPTION

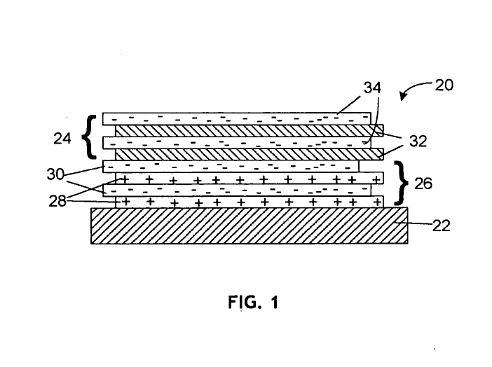

FIG. 1 shows a structure 20 including a substrate 22, a first plurality of bilayers 24 on the substrate, and a second plurality of bilayers 26 between the substrate and the first plurality of bilayers. For convenience and simplicity, second plurality of bilayers 26 is shown as having two bilayers that include alternating cationic polyelectrolytes 28 and anionic polyelectrolytes 30. Similarly, first plurality of bilayers 24 is shown as having two bilayers that include alternating layers including antimicrobial peptides (Amps) 32 and anionic polyelectrolytes 34. As described herein, in some embodiments, structure 20 is formed using a layer-by-layer (LBL) technique in which layers (e.g., polyelectrolytes 28, 30, 34 and AmPs 32) are formed one at a time on substrate 22. This technique allows structure 20 to be formed with great control and selectivity, thereby allowing the release of AmPs 32 to be controllable and tunable.

In use, structure 20 is capable of controllably releasing, for example, under physiological conditions, antimicrobial peptides 32 that are incorporated or encapsulated in the structure. For example, structure 20 can be implanted into a living organism (e.g., a human) or applied to a treatment site (e.g., a wound), and AmPs 32 can be released from the structure to provide a desired treatment (e.g., to reduce or to eliminate microbes). The incorporation or encapsulation of AmPs 32 into structure 20 can be performed under non-physiological conditions.

Substrate 22 can include (e.g., be formed wholly of) a variety of materials. In some embodiments, substrate 22 includes a biocompatible material, for example, when structure 20 is to be implanted into a body. Substrate 22 can include materials such as metals, e.g., gold, silver, platinum, and aluminum; metal-coated materials; metal oxides; plastics; ceramics; silicon; glasses; mica; graphite; hydrogels; and polymers. Examples of polymers include polyamides, polyphosphazenes, polypropylfumarates, polyethers, polyacetals, polycyanoacrylates, polyurethanes, polycarbonates, polyanhydrides, polyorthoesters, polyhydroxyacids, polyacrylates, ethylene vinyl acetate polymers and other cellulose acetates, polystyrenes, poly(vinyl chloride), poly(vinyl fluoride), poly(vinyl imidazole), poly(vinyl alcohol), poly(ethylene terephthalate), polyesters, polyureas, polypropylene, polymethacrylate, polyethylene, poly(ethylene oxide)s and chlorosulphonated polyolefins; and combinations thereof. In some embodiments, substrate 22 includes one material coated with a second material, or two materials (e.g. a polymer and a non-polymer) may be combined to form a composite. Materials with an inherently charged surface can be particularly attractive for use in substrate 22 for LBL assembly. Substrate 22 can be degradable (e.g., formed of a degradable polymer or alloy) or non-degradable.

Alternatively, a range of methods can be used to charge the surface of a material, including plasma processing, corona processing, flame processing, and chemical processing, e.g., etching, micro-contact printing, and chemical modification. For example, plastics can be used included in substrate 22, particularly if they have been chemically modified to present polar or charged functional groups on the surface. Additionally or alternatively, substrate 22 can be primed with specific polyelectrolyte bilayers such as LPEI/SPS, PDAC/SPS, PAH/SPS, LPEI/PAA, PDAC/PAA, and PAH/PAA bilayers, that form readily on weakly charged surfaces and occasionally on neutral surfaces. Primer layers can provide a uniform surface layer for further LBL assembly and are therefore can be well suited to applications that include the deposition of a uniform thin film on a substrate that includes a range of materials on its surface, e.g., an implant or a complex tissue engineering construct.

AmPs 32 include to oligo- or polypeptides that are capable of killing (e.g., bacteriocidal) and/or inhibiting the growth of (e.g., bacteriostatic) microorganisms, such as bacteria, yeast, fungi, mycoplasma, viruses or virus infected cells, and/or protozoa. In some embodiments, AmPs 32 have anticancer activity. In some embodiments, AmPs 32 are cationic molecules with spatially separated hydrophobic and charged regions. Examples of AmPs 32 include linear peptides that form an α-helical structure in membranes or peptides that form β-sheet structures optionally stabilized with disulfide bridges in membranes. Examples of AmPs 32 include cathelicidins, defensins, dermcidin, ponericin, and more specifically magainin 2, protegrin, protegrin-1, melittin 11-37, dermaseptin 01, cecropin, caern, ovispirin, and alamethicin. Naturally occurring AmPs include peptides from vertebrates and non-vertebrates, including plants, humans, fungi, microbes, and insects. AmPs are also described in U.S. Published Patent Application Nos. 2007/0254006 and 2007/019773.

Still referring to FIG. 1, at least some (e.g., all) of the polyelectrolytes in first and/or second plurality of bilayers 24, 26 include a degradable polyelectrolyte. Examples of degradable polyelectrolytes include those that are hydrolytically degradable, biodegradable, thermally degradable, and/or photolytically degradable. Examples of hydrolytically degradable polymers include certain polyesters, polyanhydrides, polyorthoesters, polyphosphazenes, and polyphosphoesters. Biodegradable polymers include, for example, certain polyhydroxyacids, polypropylfumerates, polycaprolactones, polyamides, poly(amino acids), polyacetals, polyethers, biodegradable polycyanoacrylates, biodegradable polyurethanes and polysaccharides. More specific biodegradable polymers include hyaluronic acid, heparin, dextran, chondroitin, polylysine, poly(lactic acid) (PLA), poly(glycolic acid) (PGA), poly(caprolactone) (PCL), poly(lactide-co-glycolide) (PLG), poly(lactide-co-caprolactone) (PLC), and poly(glycolide-co-caprolactone) (PGC). The properties of these and other polymers and methods for preparing them are further described in, for example, U.S. Pat. Nos. 6,123,727; 5,804,178; 5,770,417; 5,736,372; and 5,716,404 to Vacanti; U.S. Pat. Nos. 6,095,148; and 5,837,752 to Shastri; U.S. Pat. No. 5,902,599 to Anseth; U.S. Pat. Nos. 5,696,175; 5,514,378; and 5,512,600 to Mikos; U.S. Pat. No 5,399,665 to Barrera; U.S. Pat. No. 5,019,379 to Domb; U.S. Pat. No. 5,010,167 to Ron; U.S. Pat. Nos. 4,806,621; and 4,638,045 to Kohn; and U.S. Pat. No. 4,946,929 to d'Amore. See also Wang et al., J. Am. Chem. Soc. 123:9480, 2001; Lim et at, J. Am. Chem. Soc. 123:2460, 2001; Langer, Acc. Chem. Res. 33:94, 2000; Langer, J. Control Release 62:7, 1999; and Uhrich et al., Chem. Rev. 99:3181, 1999. Co-polymers, mixtures, and adducts of these polymers may also be used.

In some embodiments, second plurality of bilayers 26 (as shown, the bilayers underlying the bilayers 24 that include AmPs 32) includes a large molecule capable of stabilizing structure 20 and affecting (e.g., significantly extending) the release of the AmPs. Examples of large molecules include proteins (e.g., large cationic proteinaceous structures), such as fibroblast growth factor II (FGF-2) and lysozyme (MW 14.7 kDa). Alternatively or additionally, anionic large molecules, such as albumin (e.g., bovine serum albumin (isoelectric point 4.7) and human serum albumin (isoelectric 5.4)), can be used. In some embodiments, the large molecules have high isoelectric points and are positively charged at physiological and lower pH. The isoelectric points can range from approximately 7.5 to approximately 11 for positively charged molecules, and can range from approximately 4.7 to approximately 7.5 for negatively charged molecules. In some embodiments, the large molecule is a polyelectrolyte, such as a long, branched polyelectrolyte capable of having a high charge. For example, the polyelectrolyte can have a molecular weight of from approximately 10 kDa to approximately 120 kDa. The molecular weight can be greater than or equal to approximately 10 kDa, approximately 20 kDa, approximately 30 kDa, approximately 40 kDa, approximately 50 kDa, approximately 60 kDa, approximately 70 kDa, approximately 80 kDa, approximately 90 kDa, approximately 100 kDa, or approximately 110 kDa; and/or less than or equal to approximately 120 kDa, approximately 110 kDa, approximately 100 kDa, approximately 90 kDa, approximately 80 kDa, approximately 70 kDa, approximately 60 kDa, approximately 50 kDa, approximately 40 kDa, approximately 30 kDa, or approximately 20 kDa.

In certain embodiments, anionic polyelectrolytes include degradable polymers with anionic groups distributed along the polymer backbone. The anionic groups, which may include carboxylate, sulfonate, sulphate, phosphate, nitrate, or other negatively charged or ionizable groupings, may be disposed upon groups pendant from the backbone and/or may be incorporated in the backbone itself.

In some embodiments, cationic polyelectrolytes include degradable polymers with cationic groups distributed along the polymer backbone. The cationic groups, which may include protonated amine, quaternary ammonium or phosphonium derived functions or other positively charged or ionizable groups, may be disposed in side groups pendant from the backbone, may be attached to the backbone directly, and/or may be incorporated in the backbone itself. For example, a range of hydrolytically degradable amine containing polyesters bearing cationic side chains have been developed (Putnam et al Macromolecules 32:3658-3662,1999; Barrera et al. J. Am. Chem. Soc. 115:11010-11011, 1993; Kwon et al. Macromolecules 22:3250-3255, 1989; Lim et al. J. Am. Chem. Soc. 121:5633-5639, 1999; Zhou et al. Macromolecules 23:3399-3406, 1990; each of which is incorporated herein by reference). Examples of these polyesters include poly(L-lactide-co-L-lysine) (Barrera et al. J. Am. Chem. Soc. 115:11010-11011, 1993; incorporated herein by reference), poly(serine ester) (Zhou et al. Macromolecules 23:3399-3406, 1990; which is incorporated herein by reference), poly(4-hydroxy-L-proline ester) (Putnam et al. Macromolecules 32:3658-3662, 1999.; Lim et al J. Am. Chem. Soc. 121:5633-5639, 1999; each of which is incorporated herein by reference), and more recently, poly[α-(4-aminobutyl)-L-glycolic acid].

In addition, poly(β-amino ester)s, for example, prepared from the conjugate addition of primary or secondary amines to diacrylates, can be used. In some embodiments, poly(β-amino ester)s have one or more tertiary amines in the backbone of the polymer, for example, one or two per repeating backbone unit. Alternatively, a co-polymer may be used in which one of the components is a poly(β-amino ester). Poly(β-amino ester)s are described in U.S. Pat. No. 6,998,115, entitled “Biodegradable poly(β-amino esters) and uses thereof” and Lynn et al, J. Am. Chem. Soc. 122:10761-10768, 2000, the entire contents of both of which are incorporated herein by reference.

Exemplary poly(β-amino ester)s are shown below. Exemplary R groups include hydrogen, branched and unbranched alkyl branched and unbranched alkenyl, branched and unbranched alkynyl, aryl, halogen, hydroxyl, alkoxy, carbamoyl, carboxyl ester, carbonyldioxyl, amide, thiohydroxyl, alkylthioether, amino, alkylamino, dialkylamino, trialkylamino, cyano, ureido, a substituted alkanoyl group, cyclic, cyclic aromatic, heterocyclic, and aromatic heterocyclic groups, each of which may be substituted with at least one substituent selected from the group consisting of branched and unbranched alkyl, branched and unbranched alkenyl, branched and unbranched alkynyl, amino, alkylamino, dialkylamino, trialkylamino, aryl, ureido, heterocyclic, aromatic heterocyclic, cyclic, aromatic cyclic, halogen, hydroxyl, alkoxy, cyano, amide, carbamoyl, carboxylic acid, ester, carbonyl, carbonyldioxyl, alkylthioether, and thiol groups.

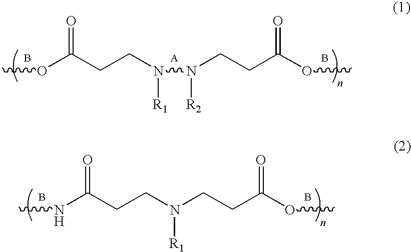

Exemplary linker groups A and B include carbon chains of 1 to 30 carbon atoms, heteroatom-containing carbon chains of 1 to 30 atoms, and carbon chains and heteroatom-containing carbon chains with at least one substituent selected from the group consisting of branched and unbranched alkyl, branched and unbranched alkenyl, branched and unbranched alkynyl, amino, alkylamino, dialkylamino, trialkylamino, aryl, ureido, heterocyclic, aromatic heterocyclic, cyclic, aromatic cyclic, halogen, hydroxyl, alkoxy, cyano, amide, carbamoyl, carboxylic acid, ester, carbonyl, carbonyldioxyl, alkylthioether, and thiol groups. The polymer may include, for example, between 5 and 10,000 repeat units.

In some embodiments, zwitterionic polyelectrolytes are used. Such polyelectrolytes may have both anionic and cationic groups incorporated into the backbone and/or covalently attached to the backbone as part of a pendant group. Such polymers may be neutrally charged at one pH, positively charged at another pH, and negatively charged at a third pH. For example, a film may be deposited by LBL deposition using dip coating in solutions of a first pH at which one layer is anionic and a second layer is cationic. If the film is put into a solution having a second different pH, then the first layer may be rendered cationic while the second layer is rendered anionic, thereby changing the charges on those layers.

The composition of the anionic and/or cationic layers 28, 30, 34 can be fine-tuned to adjust the degradation rate of each layer within structure 20. For example, the degradation rate of hydrolytically degradable polyelectrolyte layers can be decreased by associating hydrophobic polymers, such as hydrocarbons and lipids, with one or more of the layers. Alternatively, layers 28, 30, 34 may be rendered more hydrophilic to increase their hydrolytic degradation rate. In certain embodiments, the degradation rate of a given layer can be adjusted by including a mixture of polyelectrolytes that degrade at different rates and/or under different conditions.

In other embodiments, one or more of anionic and/or cationic layers 28, 30, 34 include a mixture of degradable and non-degradable compounds, e.g., polyelectrolytes. Exemplary non-degradable polyelectrolytes include poly(styrene sulfonate) (SPS), poly(acrylic acid) (PAA), linear poly(ethylene imine) (LPEI), poly(diallyldimethyl ammonium chloride) (PDAC), and poly(allylamine hydrochloride) (PAH).

Alternatively or additionally, the degradation rate may be fine-tuned by associating and/or mixing non-biodegradable, yet biocompatible polymers (polyionic or non-polyionic) with one or more of anionic and/or cationic layers 28, 30, 34. Examples of non-biodegradable, yet biocompatible polymers include polystyrenes, certain polyesters, non-biodegradable polyurethanes, polyureas, poly(ethylene vinyl acetate), polypropylene, polymethacrylate, polyethylene, polycarbonates, and poly(ethylene oxide)s.

Furthermore, because structure 20 can be produced in a layer-by-layer fashion, the composition of individual layers may be varied to tailor the degradation rate of various portions of the structure. For example, the upper layers of structure 20, closer to the surface, may be adjusted to degrade faster than the layers of the structure closer to substrate 22, or vice versa. Depending on the thickness of structure 20 (e.g., a film including first and second plurality of bilayers 24, 25), the degradation rate may be varied cyclically (e.g., for periodic release). Additionally or alternatively, the upper layers of structure 20, closer to the surface, may be adjusted to degrade under a first set of conditions (e.g., endosomal conditions), while the layers of the structure that are closer to substrate 22 are adjusted to degrade under a second set of conditions (e.g., physiological conditions).

In some embodiments, one or more of anionic and/or cationic layers 28, 30, 34 is modified to affect the diffusion of materials (e.g., AmPs) within structure 20. For example, one or more of anionic and/or cationic layers 28, 30, 34 may be covalently cross-linked to affect (e.g., prevent) diffusion of materials across the layers of structure 20. For example, a bilayer of two polymers of opposite charge may be cross-linked thermally or by other mechanisms. Thermal cross-linking may be achieved by heating the film for a particular period of time. Chemical cross-linking may be achieved by exposing a film to UV light. For example, polymers having double bonds in and/or pendant to the backbone may be employed in structure 20 and cross-linked after deposition. In other embodiments, reactive groups, such as carboxyl, thiol, amine, hydroxyl, or halogen, may be used to covalently cross-link materials. These groups may be made more reactive by methods such as, for example, using carbodiimides or other groups such as isocyanates, 3-[(2-aminoethyl)dithio]propionic acid, and succinimidyl 4-[N-maleimidomethyl]cyclohexane-1-carboxylate (SMCC), that provide additional reactivity and good leaving groups. Additional groups for cross-linking can depend on the composition of the various layers. A variety of cross-linking agents are available from Pierce Biotechnologies, Rockford, Ill.

The dimensional parameters of structure 20 are not particularly limited. In some embodiments, first plurality of bilayers 24, which includes AmPs 32, has a thickness of approximately 2 nm to approximately 1,000 nm. Expressed another way, first plurality of bilayers 24 can include approximately 2 nm to approximately 20 nm of each layer of AmPs 32 and layer 34. Second plurality of bilayers 26 can have a thickness of approximately 2 nm to approximately 1,000 nm. Expressed another way, second plurality of bilayers 26 can include approximately 2 nm to approximately 20 nm of each layer 28, 30. For each plurality of bilayers, the thickness, independently, can be greater than or equal to approximately 2 nm, approximately 100 nm, approximately 200 nm, approximately 300 nm, approximately 400 nm, approximately 500 nm, approximately 600 nm, approximately 700 nm, approximately 800 nm, or approximately 900 nm; and/or less than or equal to approximately 1,000 nm, approximately 900 nm, approximately 800 nm, approximately 700 nm, approximately 600 nm, approximately 500 nm, approximately 400 nm, approximately 300 nm, approximately 200 nm, or approximately 100 nm. For each plurality of bilayers, the thickness of each layer, independently, can be greater than or equal to approximately 2 nm, approximately 5 nm, approximately 10 nm, or approximately 15 nm; and/or less than or equal to approximately 20 nm, approximately 15 nm, approximately 10 nm, or approximately 5 nm.

While FIG. 1 shows structure 20 as having only two plurality of bilayers 24, 26, in other embodiments, the structure includes additional plurality of bilayers. The additional plurality of bilayers can be similar or identical to first plurality of bilayers 24 (which includes AmPs 32) or second plurality of bilayers 26. For example, a third plurality of bilayers similar or identical to second plurality of bilayers 26 can be formed on top of first plurality of bilayers 24 to delay release of AmPs 32. First and second plurality of bilayers 24, 26 can be repeatedly formed on substrate 22 to provide periodic release of AmPs 32 over an extended period of time. In some embodiments, the additional plurality of bilayers is different from first and second plurality of bilayers 24, 26. For example, the different plurality of bilayers can include a different bioactive agent to provide a different treatment than that provided by AmPs 32. As another example, the different plurality of bilayers can include different compounds with different degradation rates.

As indicated above, structure 20 can be formed using a layer-by-layer technique, as described herein and illustrated by the examples below. The LBL technique is also described in, for example, U.S. Published Patent Application 2007/0020469. Generally, the LBL assembly of structure 20 includes a series of dip coating steps in which substrate 22 is dipped in alternating polycationic (e.g., AmPs 32) and polyanionic solutions. Additionally or alternatively, formation of alternating polycationic and polyanionic layers may also be achieved by spray coating, brush coating, roll coating, spin casting, or combinations of any of these techniques. In preparing a structure (e.g., a thin film) that degrades with a desired rate and profile, various thin film compositions may be tested experimentally. The degradation rates and profiles of structure 20 can, for example, be investigated using a variety of techniques, including ellipsometry, profilometry, dynamic light scattering (DLS), zeta-potential analysis, quartz crystal microbalance (QCM), and atomic force microscopy (AFM). The QCM method can be used with rough films and allows continuous monitoring without removal of the thin films from a degradation milieu. AFM can be also used to monitor changes in a multi-layer surface morphology as a function of degradation.

Additionally or alternatively, the rate at which a non-degradable structural polymer, a degradable polymer, and/or AmPs 32 is released from structure 20 can be monitored. If the released entity absorbs or emits light in an uncrowded region of the ultraviolet or visible electromagnetic spectrum, the rate of release can be measured by UV-visible spectroscopy. In addition, a variety of synthetic and recombinant techniques exist to attach a light absorbing or emitting group, e.g., a fluorescent group or a dye, to a polymer or small molecule that lacks such functionality. Alternatively, a model chromic compound, e.g., the commercially available photochromic polyanion PAZO, can be incorporated. Radioisotopes may also be used to label components of structure 20, following which the activity of a solution containing the released material may be measured using known techniques. For the detection of biomolecules such as proteins and peptides, colorimetric assays such as the BCA (bicinchoninic acid) assay or Bradford assay may also be used to detect native entities that have not been modified by fluorophores, dyes, or radioactive tags.

In use, structure 20 is capable of releasing AmPs 32 according to a controllable profile. For example, structure 20 can include a biocompatible substrate 22 and layers 28, 30, and 32, and the structure can be implanted into a subject to release AmPs 32. As another example, substrate 22 can be a wound dressing (e.g., a bandage) that is applied to a treatment site to release AmPs 32. Degradation of layers 28, 30, and 32 can be characterized by the substantially sequential degradation of at least a portion of the layers. The degradation may be at least partially hydrolytic, at least partially enzymatic, at least partially thermal, and/or at least partially photolytic.

While a number of embodiments have been described, the invention is not so limited.

As an example, structure 20 can be used to create a degradable substrate or vehicle for cell seeding and culture. Some cells, for example, chondrocytes, proliferate better when deposited on a substrate to which they can attach. To use these cells in other applications, they may need to be separated from the substrate. Cells may be deposited on the surface of multi-layer structure 20 and maintained in vitro. As structure 20 degrades, the cells are released into the surrounding medium, freeing them for seeding onto tissue engineering matrices or for analysis. Integrins and cell adhesion sequences (e.g., the RGD sequence) may be included in the top layer or layers of the film to facilitate cell adhesion. Integrins are part of a large family of cell adhesion receptors which are involved in cell-extracellular matrix and cell-cell interactions. The RGD sequence, present in proteins such as fibronectin, has been shown to be active in promoting cell adhesion and proliferation (see Massia et a, J. Cell. Biol. 14;1089, 1991).

As other examples, structure 20 may include electroactive polymers. In the presence or absence of a voltage, conductive polymers may enhance the proliferation and metabolism of cells deposited thereon (see U.S. Pat. Nos. 6,095,148, and 6,190,893). The voltage may be an externally applied voltage. Alternatively, a voltage may be applied by native tissue, for example, nerve. Bone is piezoelectric, and physiologic loading can generate a potential across a structure 20 implanted therein. Examples of electroactive polymers include polypyrrole, poly(p-phenylene), poly(p-phenylene vinylene), polythiophene, polyaniline, polyporphyrin, polyheme, and derivatives thereof. These polymers may be derivatized. For example, hydrocarbon groups, methoxy, cyano, phenyl, alkoxy, amino, and halides may be added to aromatic groups in the polymer, and except for halides (which can lead to the production of poly(phenylene acetylene)), to the non-aromatic carbons. In embodiments in which structure 20 is intended for biological applications, the resulting derivative is biocompatible.

Structure 20 can include a wide range of cell types and is not limited to any specific cell type. Examples of cell types include bone or cartilage forming cells, such as chondrocytes and fibroblasts, other connective tissue cells, epithelial cells, endothelial cells, blood vessel cells, cancer cells, organ cells, such as hepatocytes, islet cells, kidney cells, intestinal cells, and lymphocytes, smooth muscle cells, skeletal muscle cells, heart muscle cells, nerve cells, and stem cells, such as human embryonic stem cells or mesenchymal stem cells.

In some embodiments, the geometry of substrate 22 is manipulated to deposit films having a variety of shapes. For example, films (e.g., plurality of bilayers 24, 26) may be deposited on particles, tubes, or spheres to facilitate a more uniform release distribution. Films may be deposited on strands such as sutures to release AmPs 32 at a surgical site. Films may be deposited onto capillary networks or tissue engineering constructs.

Three-dimensional structures can be created, for examples, as described in U.S. Published Patent Application 2007/0020469. For example, a film may be deposited on a substrate that can be dissolved to leave a hollow shell of the film. Alternatively, multiple layers may be deposited having regions that are more and less degradable. Degradation of the degradable portions can leave a three-dimensional microstructure. In a first step, the surface of a substrate is divided into regions in which LBL deposition of a film is more or less favorable. In some embodiments, a pattern of self-assembled monolayers (SAMs) is deposited on a substrate surface by microcontact printing (see, for example, U.S. Pat. No. 5,512,131, Kumar et al., Langmuir 10:1498, 1994; Jiang and Hammond, Langmuir, 16;8501, 2000; Clark et al., Supramolecular Science 4:141, 1997; and Hammond and Whitesides, Macromolecules 28:7569, 1995). In certain embodiments, the surface of substrate 22 is neutral and the exposed surface of the deposited SAMs is polar or ionic (i.e., charged). A variety of polymers with polar or ionic head groups are known. In other embodiments, a uniform coating of a polymer is deposited on substrate 22, and that coating is transformed into a patterned layer by means of photolithography. Other embodiments include the surface of substrate 22 being selectively exposed to plasmas, various forms of electromagnetic radiation, or to electron beams. yet other embodiments, substrate 22 possess the desired surface characteristics by virtue of its inherent composition. For example, substrate 22 may be a composite in which different regions of the surface have differing compositions, and thus different affinities for the polyelectrolyte to be deposited.

In a second step, polyelectrolyte layers of alternating charge are deposited by LBL on receptive regions of the surface, as described for a homogeneous surface above and selective regions in Jiang and Hammond, Langmuir, 16:8501, 2000; Clark et al., Supramolecular Science 4:141, 1997; and Hammond and Whitesides, Macromolecules 28:7569, 1995. The surface is subsequently flooded with a non-degradable polymer and placed in a medium wherein at least a portion of the polyelectrolyte layers degrade, thereby creating a three-dimensional “tunnel-like” structure that reflects the pattern on the original surface. More complex microstructures can be created based on these principles (e.g., by depositing SAMs with different electrostatic character in different regions of a substrate surface and/or by iterative additions of subsequent structures above the deposited non-degradable polymer).

In some embodiments, structure 20 includes one or more barrier layers, as described in U.S. Published Patent Application 2007/0020469. For example, a barrier layer can separate first plurality of bilayers 24 from other plurality of bilayers formed on the top of the first plurality of bilayers. The barrier layer (e.g., one or more cross-linked polyelectrolyte layers) can affect both the duration of a release delay and the rate of release following this delay. For example, a barrier layer can be broadly controlled by adjusting the number of cross-linked bilayers and the degree of cross-linking, for example, by varying the time and temperature of cross-linking or the concentration of cross-linkable groups.

In some embodiments, structure 20 further includes one or more layers including small molecules, biomolecules, and/or bioactive agents that are released as the structure degrades.

The following Examples are illustrative and not intended to be limiting.

### EXAMPLES

### Materials and Methods.

Materials. Poly(β-amino esters) (referred to as Poly X, X=1 and 6A, shown below) were synthesized as previously described. Lynn, D. M. and Langer, R. J. Am. Chem. Soc., 2000, 122, 10761-10768.) Silicon wafers (test grade n-type) were purchased from Silicon Quest (Santa Clara, Calif.). Linear poly(ethylenimine) (LPEI, Mₙ=25 k) was received from Polysciences, Inc. Poly (sodium 4-styrenesulfonate) (PSS, Mₙ=1M) was purchased from Sigma-Aldrich (St. Louis, Mo.). Sodium hyaluronate (or hyaluronic acid (HA), Mₙ=1.76 MDa) was purchased from Lifecore Biomedical, Inc. (Chaska, Minn.). All antimicrobial peptides (AmPs), both fluorescently labeled (denoted as AmP*) and native versions, were courtesy of the Greg Stephanopoulos group and synthesized by the MIT Biopolymers Lab. Please see Table 1 for the list of AmPs considered under this study. All materials and solvents were used as received without further purification.

TABLE 1
List of antimicrobial peptides

| | |
|---|---|
| Name | Sequence |

| | |
|---|---|
| Dermaseptin (Derm) | ALWKTLLKKVLKA |
| Melittin (Mel) | GIGAVLKVLTTGLPALISWIKRKRQQ |
| Ponericin G1 | GWKDWAKKAGGWLKKKGPGMAKAALKAAMQ |
| (“Pon”) | |

Staphylococcus aureus (ATCC 25923, no antibiotic resistance) and methicillin-resistant S. aureus (MRSA, ATCC 700698) were purchased from American Type Culture Collection (ATCC, Manassas, Va.). Cation-adjusted Mueller Hinton Broth II (CMHB) was purchased from Difco™ (BD, Franklin Lakes, N.J.). Bacto Agar™ was also purchased from Difco™. Gentamicin standard discs, 10 μg loading, were purchased from BD Biosciences (Franklin Lake, N.J.) as BBL™ Sensi-Disc™. Micro BCA Protein Assay Kit was obtained from Pierce (Rockford, Ill.).

Preparation of Polyelectrolyte Solutions. Dipping solutions containing Poly X, HA, and heparin were made at a concentration of 10 mM with respect to the polymer repeat unit in 100 mM sodium acetate buffer (pH 5.1 by glacial acetic acid). AmP dipping solutions were prepared by dissolving lyophilized samples or diluting liquid stock with sodium acetate buffer and glacial acetic acid to result in a solution of 0.5-1 mg/mL AmP in 100 mM sodium acetate at pH 3.0. Nondegradable base layers were deposited from dipping solutions of LPEI and PSS in deionized water pH adjusted to 4.25 and 4.75, respectively. Deionized water used to prepare all solutions was obtained using a Milli-Q Plus (Bedford, Mass.) at 18.2 M Ω.

Polyelectrolyte Deposition. All polyelectrolyte LBL thin films were constructed as follows according to the alternate dipping method. (Decher, G. Science, 1997, 277, 1232-1237.) Silicon wafers were cut into rectangular substrates approximately 2.0 cm×0.5cm each. The substrates were rinsed with methanol and deionized water, dried under nitrogen, and plasma etched in oxygen using a Harrick PDC-32G plasma cleaner at high RF power for 1 min. Layer-by-layer thin film deposition was performed using a Carl Zeiss HMS Series Programmable Slide Stainer. A ten-bilayer nondegradable base film ((LPEI/PSS)₁₀) was deposited by submerging plasma treated silicon substrates in an LPEI dipping solution for 5 minutes, then a cascade rinse cycle consisting of three deionized water rinsing baths (15, 30, and 45 seconds, respectively). Substrates were then submerged in a PSS dipping solution for 5 minutes followed by the same cascade rinsing cycle, and the entire process was repeated ten times. Next, degradable films were deposited on the existing polyanion-terminated base layer by repeating the above procedure with the [(PolyX/HA)ₐ(AmP/HA)_{b}]ₙ architecture, dipping for 10 min in each of the Poly X, HA, and GS solutions and repeating the (Poly X/HA)ₐ(AmP/HA)_{b} structure as many times (n) as desired. Poly X and HA dipping solutions were re-made every 24 hours.

Measurement of Film Thickness. Following deposition, films were immediately removed from the final rinsing bath and air dried. Film thickness was determined either by ellipsometry at ten different predetermined locations on the film surface or by profilometry at three different scratch sites. All measurements were performed in triplicate. Dry state ellipsometric measurements were conducted using a Gaertner Variable Angle Ellipsometer (6328 nm, 70° incident angle) and accompanying Gaertner Ellipsometer Measurement Program (GEMP) Version 1.2 software interface. Profilometric measurements were taken on a KLA-Tencor P-10 Profilometer.

Measurement of Drug Release. For release assessments by either fluorescence or bicinchoninic acid (BCA) protein assay, calibration curves were established for each specific type of AmP by running a set of standards at known concentrations within a range relevant to observed release concentrations, and performing linear regression on the concentration vs. fluorescent/colorimetric signal to establish a calibration curve. For drug release assessment by fluorescence measurement, [(Poly X/HA)ₐ(AmP*/HA)_{b}]ₙ films were immersed in 1 mL of pre-warmed 37 C phosphate buffered saline (PBS) in a tightly capped vial wrapped with aluminum foil to block out light. Vials were kept in cell incubators to maintain 37 C. At predetermined time periods, three samples of 0.100 mL release buffer would be withdrawn from the vial and transferred each into the well of a black 96-well plate and read in a fluorescence microplate reader (fmax, Molecular Devices, Sunnyvale, Calif.). After reading, all buffer samples would be returned to the vial to maintain 1 mL of total release buffer. For drug release assessment by BCA assay, a [(PolyX/HA)ₐ(AmP/HA)_{b}]ₙ film was trimmed into smaller pieces and immersed in 0.5 mL of PBS (Ayako Oyane, H.-M. K., Takuo Furuya, Tadashi Kokubo, Toshiki Miyazaki, Takashi Nakamura, Journal of Biomedical Materials Research Part A, 2003, 65A, 188-195) in an Eppendorf tube maintained at 37° C. in a water bath. A 0.150 mL sample was extracted at predetermined time points (every 1-5 minutes at the beginning, then gradually increasing the time intervals) and replaced with fresh 0.150 mL pre-warmed PBS. Aliquots of 0.150 mL release samples were stored at −20 C until all samples were ready for BCA. Each 0.150 mL sample was then diluted to 0.300 mL total, allowing for triplicate assessment at 0.100 mL each. BCA assay was run according to manufacturer's product insert, using the microplate method.

Staphyloccocus aureus macrodilution assays. All liquid assays were performed in cation-adjusted Mueller Hinton Broth II (CMHB). Qualitative assays were performed following standard macrodilution methods as outlined by the National Committee on Clinical Laboratory Standards (Standards, N. C. f. C. L. Journal, 1999, Approved standard M26-A) with a challenge of 10⁵ CFU/mL. For assays involving co-incubation with films deposited on silicon, 24-well plates were used, with 0.5 mL of liquid culture per well. Briefly, each square-cut silicon substrate (1.0 cm×1.0 cm), either bare or coated depending on the test group, was placed flat in the center of a well in a 24-well plate, polished side up. Each well was then filled with 0.50 mL of S. aureus in exponential growth phase at 10⁵ CFU/mL in CMHB, completely immersing the substrate. Quantitative assays were done in 96-well plates with 150 μL of liquid culture per well, with 135 μL of test media and 15 μL of inoculation culture at 10⁶ CFU/mL in CMHB. All test media were sterile-filtered through 0.2 μm membranes prior to use. Estimated test media conditions take the 9:10 dilution into account. For each set of assays, three wells were filled with culture fluid with no bacteria inoculated, while three negative controls were subject to the same bacterial challenge without any substrate. The plate was incubated at 37° C. under gentle shaking for 16-18 hours. Cell density was read at OD 600 nm in a BioTek® PowerWave™ XS Microplate Spectrophotometer with accompanying Gen5 program Version 1.00.14. All treatments, whether direct infusion into culture or co-immersion of film substrates with the culture, were administered from the time of seeding to data observation. Cultures were incubated at 37° C. for 16-18 hours under gentle shaking before observation.

AmPs were incorporated through a multilayer heterostructure with specific architecture [(Poly X/HA)(AmP/HA)]ₙ, in which Poly X is a degradable poly(β-amino ester) and HA is hyaluronic acid. Each repeat of (Poly X/HA)(GS/HA) constitutes a tetralayer. Two degradable poly(β-amino esters) were studied: Poly 1 (Mn=15.5 k) and Poly 6 (Mn=16.7 k), with structures shown below.

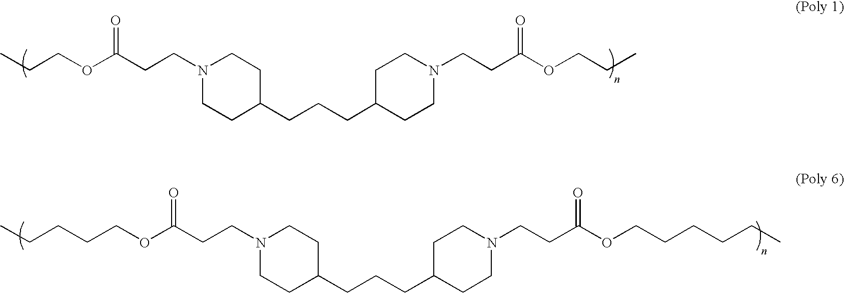

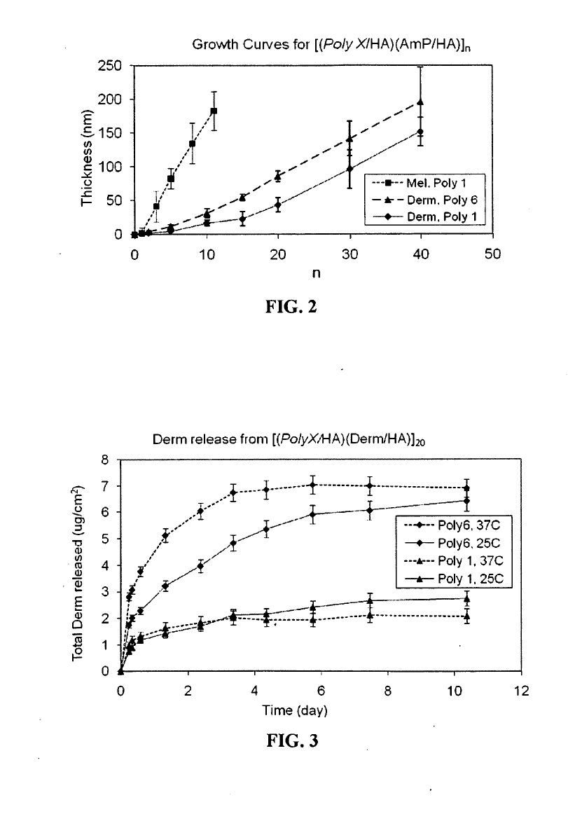

Evaluation of different Poly X's in tetralayer structure. To demonstrate control over AmP release rate through the choice of Poly X, tetralayered films formulated with different Poly 1 vs. Poly 6 were compared. Dermaseptin was used in this study, along with Melittin which had a higher activity against S. aureus. FIG. 2 shows the growth curves of [(Poly 1/HA)(Mel/HA)]ₙ, [(Poly 1/HA)(Derm/HA)]ₙ, and [(Poly 6/HA)(Derm/HA)]ₙ. Thicknesses were measured by ellipsometry, and error bars represent standard deviations among multiple sampling locations on each substrate. The growth curves indicate that [(Poly X/HA)(AmP/HA)]ₙ generally grew in a linear fashion, suggesting that the AmP did not readily diffuse within the film.

Release of Dermaseptin from [(Poly X/HA)(Derm/HA)]₂₀ films was assessed at both 25° C. and 37° C. The resulting release profiles are plotted in FIG. 3. For both types of films, releases at 37° C. were faster than those at 25° C., although the difference was much more pronounced for Poly 6 films. For Poly 1, there was essentially no difference between the two temperatures especially in consideration of the error bars. A possible explanation for the observed differences in temperature dependence was that Poly 6's hydrophobicity effectively discouraged approach by water molecules to attack its ester bonds, whereas Poly 1 was not hydrophobic enough to deter rapid seepage of water molecules into its films. Hence, the kinetic enhancement by temperature elevation would be more noticeable for a Poly 6 film. The hydrophobic effect could also explain the more sustained releases seen from Poly 6 films.

Evaluation of incorporating different AmPs All experiments up to this point were performed with fluorescence assessment of AmP quantity. However, significant deviations in release quantities from identical films made with different batches of FITC-Dermaseptin (as made by the MIT Biopolymers Lab) were observed. In addition, the RF signals could fluctuate from one measurement to another due to their sensitivity to ambient light (despite careful controls in foil wrapping and keeping the room dark) and possible decay over time. The FTIC labeling density was suspected to vary from batch to batch, and a simultaneous comparison was made of calibration curves constructed from different batches of FTIC-Dermaseptin. The labeling density varied by as much as 50% between three randomly chosen batches, and could vary by a higher percentage between the two most disparate batches available. Hence, a new AmP quantification protocol was defined

A promising method was the BCA (bicinchoninic acid) protein assay, an assay based on the reduction of Cu²⁺ to Cu¹⁺ by protein in an alkaline medium followed by calorimetric detection of Cu¹⁺ by bicinchoninic acid. To verify the feasibility of using the BCA assay to measure AmP concentrations, a calibration curve was constructed using the available fluorescently labeled Dermapsetin, and a satisfactory linear trend was found.

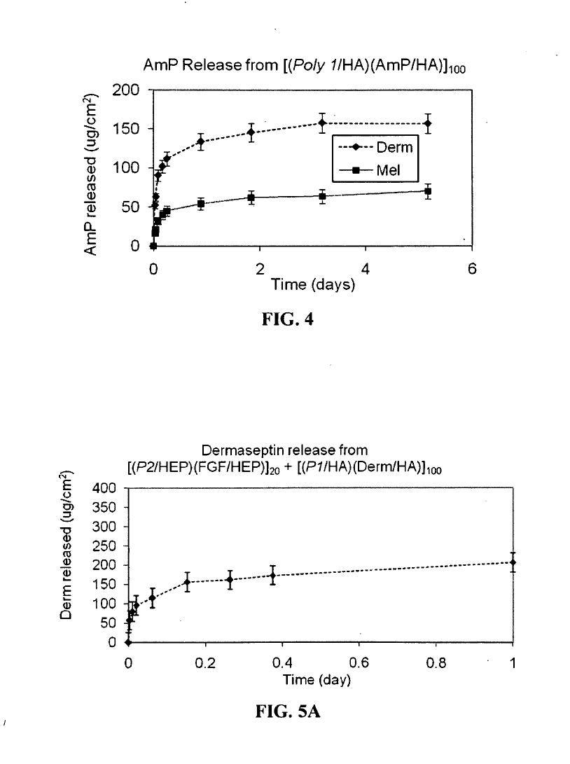

BCA calibrations for both Dermaeptin and Melittin were then constructed, and releases of both AmPs from [(Poly 1/HA)(AmP/HA)]₁₀₀ films were assessed by BCA were constructed with either Dermaseptin (Derm) or Melittin (Mel) as the AmP. Thicker films were used to ensure adequate BCA signal for accuracy. As FIG. 4 shows, BCA assessment yielded similar release profiles as those produced through fluorescence quantification. However, the dosages were markedly lower under BCA measurements. For example, [(Poly 1/HA)(Dermaseptin/HA)]₅₀ under fluorescence assessment gave 250 ug/cm, whereas a 100-tetralayer film assessed by BCA gave 150 ug/cm². The fluorescence data was thought to be less accurate due to its batch-to-batch variability and lack of stability. A 20-tetralayer film released 2.5 ug/cm² of Dermaseptin under fluorescence detection, according to the method of quantification used. The resulting release profiles are shown in FIG. 4, which demonstrates similar release kinetics between the two AmP candidates, though different dosages.

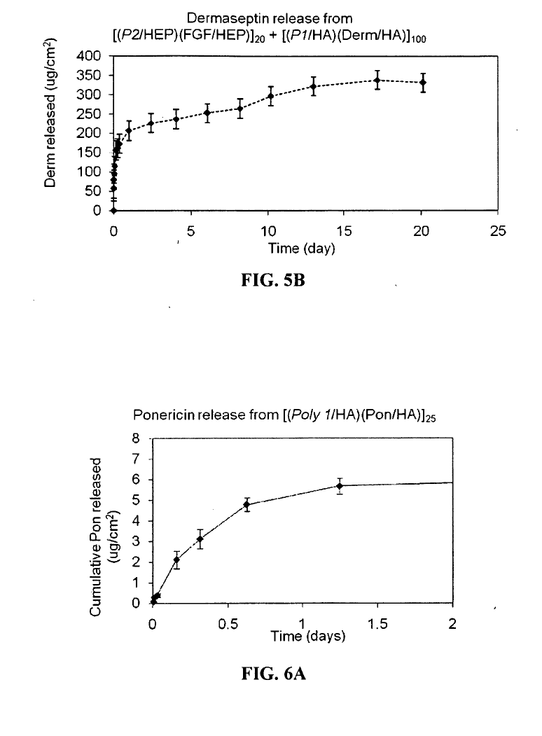

Co-release with bFGF. Combination drug films composed of [(Poly 2/heparin)(bFGF/heparin)]ₙ+[(PolyX/HA)(Dermaseptin/HA)]m were constructed. The resulting Dermaseptin release is shown in FIGS. 5A and 5B in which exhibit the same set of data displayed on different time scales. As plots show, the [(Poly 2/heparin)(bFGF/heparin)]ₙ underlayers could indeed extend the release of Dermaseptin from 4 days (FIG. 4) to about 2 weeks. In addition, the dosage of Dermaseptin was noticeably increased from 150 ug/cm² to 325 ug/cm².

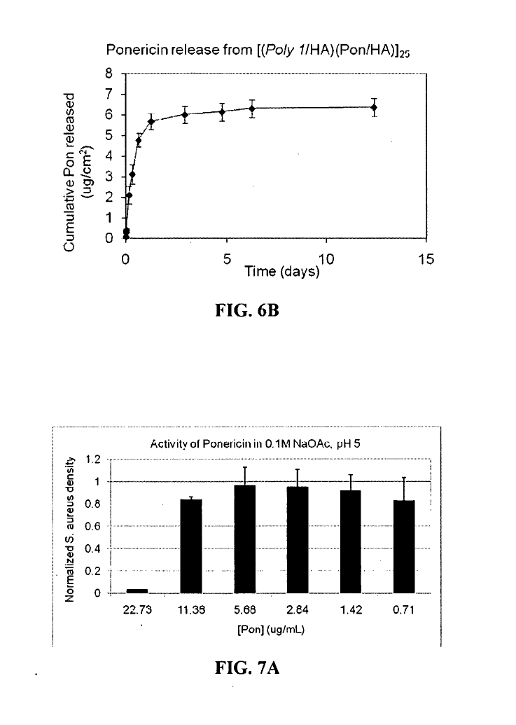

As FIG. 5A shows, about 50% of the total release (325 μg/cm² total) occurred within the first 2.5 hours. However, the remaining 50% was released in a steady, pseudo-linear fashion over the subsequent 2 weeks. This release profile may be particularly suitable for remedial treatment of device infections. These complications generally need an immediate burst release of a large dose of antibiotics to kill the infection in place, followed by a sustained, lower dose release to ensure complete eradication. Hence, the profile achieved a protein co-release film would be appropriate for such needs. Ponericin encapsulation and release. Efforts on AmP encapsulation shifted towards the AmP Ponericin G1, which can be particularly active against S. aureus and a variety of other gram-positive and gram-negative microorganisms, with potentially higher biocompatibility given its low hemolytic activity. Assessments on Ponericin release are shown in FIGS. 6A and 6B.

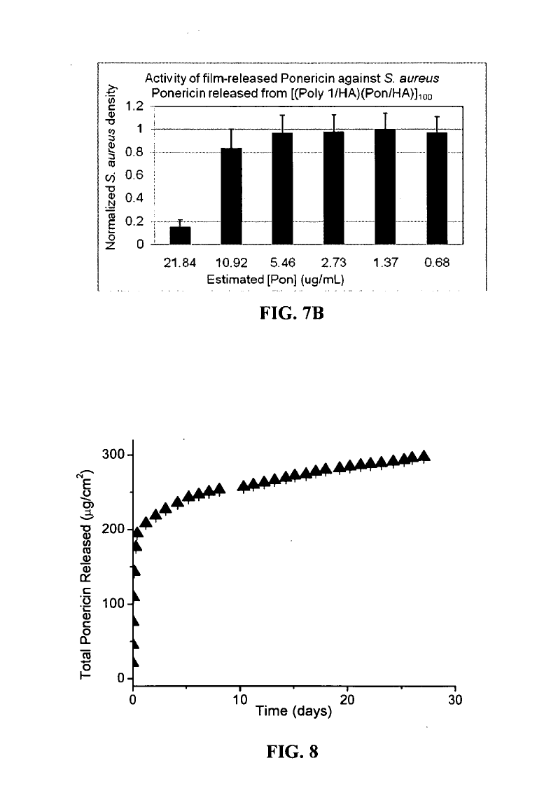

Antimicrobial activity of Ponericin as released from LbL assemblies. In vitro activity of Ponericin, both in dipping solution and as released from films, were assessed against S. aureus. Serial dilutions of free Ponericin in 0.1M sodium acetate and elution buffers from [(Poly 1/HA)(Pon/HA)]₁₀₀ films were administered to S. aureus cultures under standard macrodilution protocol. The results are shown in FIGS. 7A and 7B.

As suggested by FIGS. 7A and 7B, a concentration of ˜11-22 μg/mL of both dipping solution or film-released Ponericin was needed to inhibit S. aureus proliferation. This range was higher than the reported MIC of 4-8 μg/mL for free Ponericin. Given the similarity of results between dipping solution and film-released Ponericin, the most likely explanation for the higher MIC was that the 0.1M sodium acetate dipping condition was sufficiently harsh to remove some of the Ponericin activity. However, once incorporated into the film, the active fraction retained its activity, and the co-excipients Poly 1 and HA did not appear to interfere with Ponericin action.

Construction of [(Poly 2/Chondroitin Sulfate)(bFGF/Chondroitin Sulfate)]₃₀+[(Poly 2/HA)(Pon/HA)]₇₅

Silicon wafers (test grade n-type) were purchased from Silicon Quest International (Santa Clara, Calif.) and used as substrate material. Pieces of this substrate material were cut, measuring 2.5 cm by 0.6 cm. The substrates were cleaned via rinsing with deionized water, followed by methanol, and again with water, and dried under nitrogen. All substrates were plasma etched (Harrick PDC-32G plasma cleaner at high RF power) for 60 seconds. The substrates were then immediately added to a Poly 2 solution.

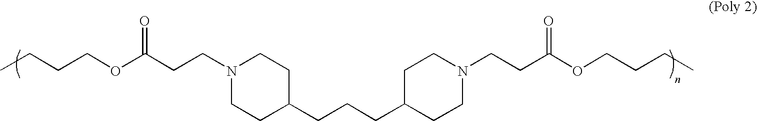

After allowing the substrates to soak for 15 minutes, a film deposition sequence for (Poly 2/Chondroitin Sulfate/bFGF/Chondroitin Sulfate)₃₀ was started. The LBL construction method is detailed in Decher, G. Science, 1997, 277, 1232-1237. A Carl Zeiss HMS Series Programmable Slide Stainer was utilized. Dipping of (Poly 2/Chondroitin Sulfate/bFGF/Chondroitin Sulfate)₃₀ started with a 10 minute soak of the substrates in Poly 2, followed by three deionized water rinse steps (10, 20, and 30 seconds). The substrates were then soaked in Chondroitin Sulfate for 7.5 minutes followed by three deionized water rinse steps (10, 20, and 30 seconds). Following these steps, the substrates were soaked in the bFGF solution for 10 minutes, followed by two deionized water rinse steps (20 and 30 seconds). After these steps, the soaking in Chondroitin Sulfate and rinsing was repeated at the same time scales used earlier. These four steps were repeated 30 times, to build a 30 tetralayer film.

Following these steps, deposition of (Poly 2/Hyaluronic Acid/Ponericin G1/Hyaluronic Acid)₇₅ was begun on the newly formed 30 tetralayer films. The same procedure as above with the bFGF film was used, where Hyaluronic Acid took the place of Chondroitin Sulfate and Ponericin took the place of bFGF. After every 25 repeats of the deposition routine, all solutions of Poly 2, Hyaluronic Acid, and Ponericin were replaced with fresh solutions. At the end of the deposition, a total of 75 tetralayers were formed on top of the existing underlying 30 tetralayers deposited with Chondroitin and bFGF earlier.

Solution Information and Dipping Bath Volumes: The polymer and drug solutions included Poly 2 (2 mg/mL concentration in 0.1 Molar Sodium Acetate Buffer (prepared from 3 Molar stock sodium acetate buffer—Sigma Aldrich, 7899)); Chondroitin Sulfate (from TCI, Tokyo, Japan, 2 mg/mL in 0.1 Molar Sodium Acetate Buffer (as prepared for Poly 2)); recombinant Human Fibroblast Growth Factor-basic (bFGF, Peprotech, Rocky Hill, N.J., 1.62 micrograms/mL in 0.1 M sodium acetate buffer (as above)); Hyaluronic Acid (2 MDa molecular weight, Lifecore Biomedical, Chaska, Minn., 3 mg/mL in 0.1 M sodium acetate buffer (as above)); and onericin G1 (GWKDWAKKAGGWLKKKGPGMAKAALKAAMQ-NH2, made by the MIT Biopolymers Lab, 1 mg/mL in 0.1 M sodium acetate buffer (as above)). The dipping bath sizes were Poly 2: 3 mL; Chondroitin Sulfate: 20 mL; bFGF: 2 mL; Hyaluronic Acid: 3 mL; and Ponericin G1: 3 mL.

Release Study: All films were removed upon deposition and dried under nitrogen. The non-plasma etched side of the substrate (non-film containing side) was wiped clean using 1 N sodium hydroxide (Sigma Aldrich) followed by large amounts of deionized water to remove all of the base. The intact films were then added to 1 mL of 1×PBS Solution (Invitrogen, Chicago, Ill.) and placed in a 37 degrees C. incubator. 400 microliter samples were removed and frozen at −20 degrees C. at predetermined time points. Fresh 400 microliters of 1×PBS were added to maintain the total volume at 1 mL. The frozen time points (400 microliters) were examined using a bicinchoninic acid (BCA) protein assay.

Referring to FIG. 8, Ponericin was incorporated and released from the structure. There was a large initial release of the Ponericin (approximately 10-15 hours) followed by sustained release (over approximately 27 days). Without being bound by theory, the AmP may have adhered to the protein, thereby allowing for increased loading and slower release.

All references, such as patents, patent applications, and publications, referred to above are incorporated by reference in their entirety.

Other embodiments are within the scope of the following claims.

What is claimed is:

1. A structure, comprising:
a substrate;
a first plurality of bilayers on the substrate, the first plurality of bilayers comprising
a first layer comprising an antimicrobial peptide having a charge, and
a second layer comprising a polyelectrolyte having a charge opposite the charge of the first layer,
wherein at least a portion of the structure is capable of degrading by sequential removal of the first layer and the second layer, and releasing the antimicrobial peptide from the structure.

2. The structure of claim 1, wherein the antimicrobial peptide is selected from the group consisting of dermaseptin, melittin, defensin, chromofungin, gramicidin, cecropin-A-melittin hybrid, and ponericin.

3. The structure of claim 1, further comprising a second plurality of bilayers on the substrate, the second plurality of bilayers comprising a third layer having a charge, and a fourth layer having a charge opposite the charge of the third layer.

4. The structure of claim 3, wherein the second plurality of bilayers is between the substrate and the first plurality of bilayers.

5. The structure of claim 3, wherein the first plurality of bilayers is between the substrate and the second plurality of bilayers.

6. The structure of claim 3, wherein the third layer comprises a protein, a growth factor, or a peptide.

7. The structure of claim 3, wherein at least one of the third layer or the fourth layer comprises a polyelectrolyte.

8. The structure of claim 3, wherein at least one of the first plurality of bilayers and the second plurality of bilayers comprises alternating polycationic and polyanionic layers, and degradation of the structure is characterized by hydrolytic degradation of at least a portion of a member of the polycationic layers, the polyanionic layers, and both.

9. The structure of claim 3, wherein at least one of the first plurality of bilayers and the second plurality of bilayers comprises a polymer selected from polyesters, polyanhydrides, polyorthoesters, polyphosphazenes, polyphosphoesters, and any combination thereof.

10. (canceled)

11. The structure of claim 3, wherein at least one of the first plurality of bilayers and the second plurality of bilayers comprises a polymer selected from poly(styrene sulfonate), poly(acrylic acid), linear poly(ethylene imine), poly(diallyl dimethyl ammonium chloride), poly(allylamine hydrochloride), and any combination thereof.

12. The structure of claim 3, wherein at least one of the first plurality of bilayers and the second plurality of bilayers comprises a biodegradable polymer.

13. The structure of claim 12, wherein the biodegradable polymer is selected from polyhydroxyacids, polypropylfumerates, polycaprolactones, polyamides, poly(amino acids), polyacetals, polyethers, biodegradable polycyanoacrylates, biodegradable polyurethanes, polysaccharides, and co-polymers, mixtures, and adducts thereof.

14. The structure of claim 3, wherein at least one of the first plurality of bilayers and the second plurality of bilayers comprises a zwitterionic polymer.

15. The structure of claim 3, wherein at least one of the first plurality of bilayers and the second plurality of bilayers comprises covalently cross-linked compounds.

16. (canceled)

17. The structure of claim 3, wherein the second plurality of the bilayers comprises an entity selected from a biomolecule, a small molecule, a bioactive agent, and any combination thereof.

18. The structure of claim 1, further comprising a layer of cells on a surface of the structure.

19. (canceled)

20. The structure of claim 1, further comprising a member of a cell adhesion sequence, a targeting sequence, and both disposed in a top layer of the structure.

21. The structure of claim, 1, wherein degradation is characterized by at least one of hydrolytic degradation, thermal degradation, enzymatic degradation, and photolytic degradation.

22. A method, comprising:
forming on a substrate a structure comprising
a first plurality of bilayers on the substrate, the first plurality of bilayers comprising
a first layer comprising an antimicrobial peptide having a charge, and
a second layer comprising a polyelectrolyte having a charge opposite the charge of the first layer,
wherein at least a portion of the structure is capable of degrading by sequential removal of the first layer and the second layer, and releasing the antimicrobial peptide from the structure.

23.-43. (canceled)

44. A method, comprising:
releasing an antimicrobial peptide from a structure comprising
a substrate;
a first plurality of bilayers on the substrate, the first plurality of bilayers comprising
a first layer comprising the antimicrobial peptide having a charge, and
a second layer comprising a polyelectrolyte having a charge opposite the charge of the first layer.

45. (canceled)

46. The method of claim 44, wherein the antimicrobial peptide is released into a living organism.

47. The method of claim 44, further comprising implanting the degradable structure in a living organism.

48. The method of claim 44, further comprising contacting the degradable structure to an area selected for medical treatment.

49.-66. (canceled)
